(19) United States
(12) Patent Application Publication
(10) Pub. No.: US 2024/0147181 A1
(43) Pub. Date: May 2, 2024

(54) Spatial Audio Effect Adjustment

(71) Applicant: Anker Innovations Technology Co., Ltd., Changsha (CN)

(72) Inventors: Lei Li, Changsha (CN); Jincong Zheng, Changsha (CN)

(73) Assignee: Anker Innovations Technology Co., Ltd., Changsha (CN)

(21) Appl. No.: 18/384,047

(22) Filed: Oct. 26, 2023

(30) Foreign Application Priority Data
Oct. 27, 2022 (CN) 202211327883.8

(51) Int. Cl. H04S 7/00

(52) U.S. Cl. CPC H04S 7/304; H04S 2400/11

(57) ABSTRACT

This application describes an audio processing method, an audio playback device, and a computer-readable storage medium. The method comprises: obtaining motion information of the audio playback device, the motion information comprising a motion trajectory, real-time motion speed, and real-time acceleration. The method further comprises determining the position and angle information of at least two virtual speakers relative to the user based on the motion information and; determining spatial audio data based on position and angle information. The method further comprises outputting the spatial audio data. In this application, the audio playback device adjusts the position parameters in the sound effect function according to user's motion information, improving the sound following effect.

### CROSS-REFERENCE TO RELATED APPLICATION

The present application claims priority to CN Application No. 202211327883.8, filed on Oct. 27, 2022. The above application is incorporated by reference in its entirety.

### FIELD

This application relates to the field of audio processing, especially the audio processing method, audio playback device, and computer-readable storage medium.

### BACKGROUND

The signal processed by the sound effect positioning algorithm can virtualize various different spatial auditory effects. A virtual speaker is the virtual sound source after the sound effect function processing, and the position of the virtual speaker is the position of the virtual sound source after the sound effect function processing. Audio that has not been processed by the sound effect function does not show the spatial sound effects provided by the virtual speaker, but is manifested as a head-in sound effect, that is, the listener feels that the audio is always playing in the ear. The current sound effect processing cannot be flexibly adjusted according to the user's movement.

### SUMMARY

This application mainly provides an audio processing method, an audio playback device, and a non-transitory computer-readable storage medium, which solves the problem that the sound effect processing in the related technology cannot be flexibly adjusted.

To solve the above technical problem, a first aspect of this application provides an audio processing method, comprising: obtaining, based on movement of a user, motion information of an audio playback device, wherein the motion information comprises a motion trajectory of the audio playback device, real-time motion speed of the audio playback device, and an acceleration of the audio playback device; based on the obtained motion information and a preset sound effect function, determining position information and angle information of at least two virtual speakers relative to the user; based on the preset sound effect function, and the determined position information and angle information of the at least two virtual speakers, determining spatial audio data; and outputting the spatial audio data via the audio playback device.

To solve the above technical problem, a second aspect of this application provides an audio playback device, which comprises a processor and a memory that are coupled to each other; the memory stores a computer program, and the processor is used to execute the computer program to implement the steps of the audio processing method provided in the first aspect above.

To solve the above technical problem, a third aspect of this application provides a non-transitory computer-readable storage medium, which stores program data. When the program data is executed by the processor, it implements the audio processing method provided in the first aspect above.

The beneficial effect of this application is: different from the existing technology, this application first obtains the motion information of the audio playback device moving with the user's movement, where the motion information comprises at least the user's motion trajectory (or the motion trajectory of the audio playback device), real-time motion speed, and real-time acceleration, and then according to the obtained user's motion trajectory, real-time motion speed, real-time acceleration, and preset sound effect function, calculate the position and angle information of at least two virtual speakers relative to the user, obtain the audio data to be processed by the audio playback device, and according to the preset sound effect function, and the obtained position and angle information of at least two virtual speakers, calculate the processed spatial audio data, and finally use the audio playback device to play the spatial audio data. The above method uses the motion information of the audio playback device following the user's movement and the preset sound effect function to calculate the position and angle information of at least two virtual speakers, and uses these at least two virtual speakers to process the audio data of the audio playback device to obtain spatial audio data, and after playing the spatial audio data, the spatial sound effect is achieved, improving the sound effect following effect under the movement state.

### BRIEF DESCRIPTION OF THE DRAWINGS

In order to more clearly illustrate the technical solutions in the examples of this application, the drawings needed in the description of the examples will be briefly introduced below. Obviously, the drawings described below are only some examples of this application. For those of ordinary skill in the art, other drawings can be obtained based on these drawings without creative effort.

FIG. 1 shows a schematic diagram of an audio process;

FIG. 2 shows a schematic diagram of a positional relationship between an audio playback device and a virtual speaker.

FIG. 3 shows a schematic diagram of another positional relationship between an audio playback device and a virtual speaker;

FIG. 4 shows a schematic diagram of another positional relationship between an audio playback device and a virtual speaker;

FIG. 5 shows a schematic diagram of a positional relationship between an audio playback device and a virtual speaker during the acceleration linear movement process;

FIG. 6 shows a schematic diagram of a positional relationship between an audio playback device and a virtual speaker during the deceleration linear movement process;

FIG. 7 shows a schematic diagram of the process of determining turning information;

FIG. 8 shows a schematic diagram of a direction of an audio playback device and a direction of a road under turning conditions;

FIG. 9 shows a schematic diagram of a change in the orientation of an audio playback device under turning conditions;

FIG. 10 shows a schematic diagram of a positional relationship between an audio playback device and a virtual speaker during the acceleration turning process;

FIG. 11 shows a schematic diagram of a positional relationship between an audio playback device and a virtual speaker during the deceleration turning process;

FIG. 12 shows a schematic diagram of a positional relationship when the user's head is turned;

FIG. 13 shows a schematic diagram of a positional relationship when the user's head is turned;

FIG. 14 shows a schematic diagram of a structure of an audio playback device;

FIG. 15 shows a schematic diagram of a structure of an audio playback device;

FIG. 16 shows a schematic diagram of a structure of a computer-readable storage medium of this application.

### DETAILED DESCRIPTION

The technical solutions in the examples of this application will be clearly and completely described in conjunction with the drawings in the examples of this application. Obviously, the described examples are only part of the examples of this application, not all of the examples. All other examples obtained by those of ordinary skill in the art without making creative effort are within the scope of protection of this application.

The terms “first” and “second” in this application are only for descriptive purposes and cannot be understood as indicating or implying relative importance or implicitly indicating the number of technical features indicated.

Therefore, the features defined as “first” and “second” can explicitly or implicitly include at least one such feature. In the description of this application, the meaning of “multiple” is at least two, such as two, three, etc., unless there is a clear specific limitation. In addition, the terms “include” and “have” and any variations are intended to cover non-exclusive inclusion. For example, a process, method, system, product, or device that includes a series of steps or units is not limited to the listed steps or units, but optionally also includes unlisted steps or units, or optionally also includes other steps or units inherent to these processes, methods, products, or devices.

The mention of “example” in this document means that the specific features, structures, or characteristics described in connection with the examples may be included in at least one example of this application. The phrase appearing at various locations in the specification does not necessarily all refer to the same example, nor is it an independent or alternative example that is mutually exclusive with other examples. Those skilled in the art explicitly and implicitly understand that the examples described in this document can be combined with other examples.

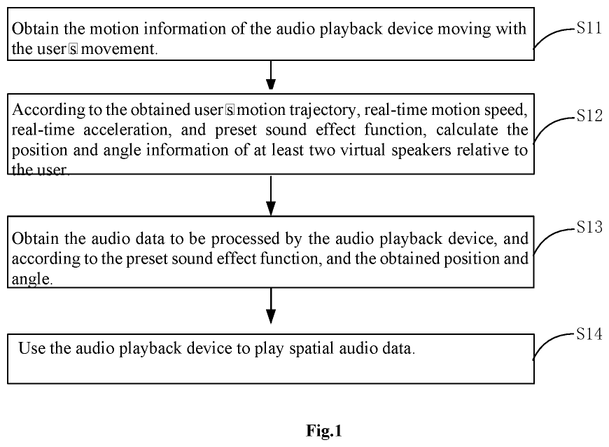

Please refer to FIG. 1, which shows a schematic diagram of a process of an audio processing method of. It should be noted that the results are the same or substantially the same, this example is not limited to the order shown in FIG. 1. This method comprises the following steps:

Step S11: Obtain motion information of an audio playback device moving with a user's movement (e.g., in relation to the user's movement).

The audio playback device comprises wired headphones, wireless wearable devices, such as wireless headphones (e.g., head-mounted headphones, semi-in-ear headphones, in-ear headphones, etc.) and wireless audio glasses, etc. The audio playback device can establish a wired or wireless communication connection with an audio source device to receive audio data to be processed from the audio source device.

For example, the audio source device can be a mobile phone, tablet computer, and/or wearable audio source devices such as watches and bracelets. The audio source device can store local audio data, or can obtain audio data as audio data to be processed through the network on an application or webpage. The audio data to be processed comprises, for example, music audio data, electronic reading audio data, etc., and audio of TV/movies, etc.

The audio playback device may move with the user's movement. For example, in a sports scene, a user wears the audio playback device, and the audio playback device is configured to move with the user's movement. The audio playback device may move in the same direction as the user's movement because the user wears the audio playback device.

In one implementation, the motion information is obtained in real time using a positioning device and an acceleration sensor. At least one of the positioning device and the acceleration sensor is set on the audio playback device, or is set on a smart mobile device that is communicatively connected with the audio playback device, such as a mobile phone, watch and other smart wearable devices.

The positioning device, for example, uses radio frequency communication technology (e.g., ultra-wideband (UWB) or Bluetooth technology, etc.) and GPS positioning technology to obtain information such as the user's angle, speed, acceleration, trajectory, etc., to achieve spatial audio follow-up in this scene. Among them, UWB technology uses the principle of Time of Flight (TOF) for ranging. UWB is a kind of ultra-wideband technology, which has the advantages of strong penetration, good anti-multipath effect, and can provide precise positioning accuracy, suitable for positioning, tracking and navigation of stationary or moving objects indoors.

The motion information comprises at least the user's motion trajectory, real-time motion speed, and real-time acceleration. More specifically, for example, the motion information comprises information indicating whether or not to the user is going to accelerate, decelerate, whether the user is under acceleration or deceleration status, the user's turning information (e.g., turn left, turn right), in a motion scene.

Step S12: According to the obtained user's motion trajectory, real-time motion speed, real-time acceleration, and preset sound effect function, calculate the position and angle information of at least two virtual speakers relative to the user.

The virtual speaker may be the virtual sound source after the sound effect function processing, and the position of the virtual speaker is the position of the virtual sound source after the sound effect function processing. Audio that has not been processed by the sound effect function does not show the sound effects provided by the virtual speaker, but is directly presented as the original audio.

The sound effect function mentioned here, for example, comprises the Head Related Transfer Functions (HRTF), also known as the anatomical transfer function (ATF), which is a personalized spatial sound effect algorithm.

Specifically, the Head Related Transfer Function describes the transmission process of sound waves from the sound source to both ears, which comprehensively considers the time difference of sound wave propagation from the sound source to both ears, the level difference of both ears caused by the shadow and scattering of sound waves by the head when the sound source is not in the median plane, the scattering and diffraction of sound waves by human physiological structures (such as the head, auricle, and torso, etc.), dynamic factors and psychological factors that cause positioning confusion when the sound source is in the upper and lower or front and back mirror positions and on the median plane. In practical applications, using headphones or speakers to reissue signals processed by HRTF can virtualize various different spatial auditory effects.

The position information comprises at least the distance between the audio playback device and the virtual speaker in the horizontal direction, and the angle information comprises at least the angle relationship between the audio playback device and the virtual speaker in the horizontal direction.

For example, the head-related transfer function can be simply represented as HRTF (L, θ1, θ2), where θ1 represents the angle parameter between the user and the virtual speaker in the horizontal direction, θ2 represents the pitch/roll angle of the audio playback device and the virtual speaker (e.g., the angle between the audio playback device and the virtual speaker in the vertical direction), and L is the distance parameter between the audio playback device and the virtual speaker, where L, θ1, and θ2 can be fixed, or, they can be modified to different values according to the motion position information and angle information of the virtual speaker relative to the user. Each virtual speaker can correspond to a head-related transfer function.

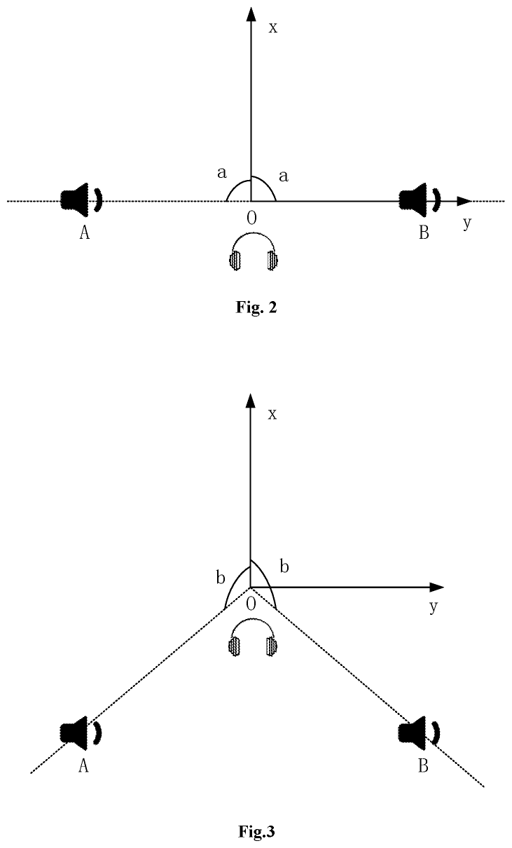

The angle parameter characterizes the angle between the virtual speaker and the front of the audio playback device. Please refer to FIG. 2 for details. FIG. 2 is a schematic diagram of the positional relationship between the audio playback device and the virtual speaker in an example of this application. FIGS. 2-4 in this document depict the positional relationships between the audio playback device and the virtual speaker in the top view. The position of the audio playback device in this example is represented as O. It can be understood that the audio playback device is worn by a person and moves together. O can also represent the user's position, the virtual speakers A and B are located on both sides of the audio playback device O. This example defines a coordinate axis in the x direction based on the audio playback device O, the x-axis is the front of the audio playback device, the y-axis refers to the right side of the audio playback device, and the xOy plane is the horizontal plane where the audio playback device is located. When the audio playback device is correctly worn by the user, the x-axis direction is the front of the user. The front direction x-axis of the audio playback device coincides with the center axis of the user's front, then the angle parameter between the virtual speaker A and the audio playback device O can be represented by the angle a formed by the line between the virtual speaker A and the audio playback device O and the x-axis. Similarly, the angle parameter between the virtual speaker B and the audio playback device O can be represented by the angle b formed by the line between the virtual speaker B and the audio playback device O and the x-axis.

Step S13: Obtain the audio data to be processed by the audio playback device, and according to the preset sound effect function, and the obtained position and angle information of at least two virtual speakers, calculate the processed spatial audio data.

The audio data to be processed, for example, is local audio data obtained from the audio source device, or audio data obtained through the network on an application or webpage as audio data to be processed, the audio data to be processed, for example, is music audio data, electronic reading audio data, etc., and the audio of TV/movies, etc.

This step can adjust the position parameters L, θ1 in the sound effect function corresponding to each virtual speaker according to the position and angle information of the virtual speaker, obtain a new sound effect function, and use the new sound effect function to process the audio data to be processed to obtain the processed spatial audio data.

In one implementation scenario, when the user's acceleration obtained is greater than 0 (indicating that the audio playback device is moving faster with the user), at least two virtual speakers are adjusted to be in the direction opposite to the movement direction of the audio playback device (e.g., the angle between the line connecting the virtual speaker and the audio playback device and the front direction of the audio playback device is greater than 90 degrees). When the user's acceleration obtained is less than 0 (indicating that the audio playback device is moving slower with the user), at least two virtual speakers are adjusted to be in the same direction as the movement direction of the audio playback device (e.g., the angle between the line connecting the virtual speaker and the audio playback device and the front direction of the audio playback device is less than 90 degrees).

The movement direction of the audio playback device is the direction in which the audio playback device follows the user. Please refer to FIGS. 2 and 3, in which the x-axis direction is the front direction. If the user's direction of travel is the x-axis direction, then when detecting accelerated movement, the virtual speaker is adjusted to be in the opposite direction of the direction indicated by x (e.g., adjusted to behind the user), the angles between the lines connecting virtual speakers A and B and audio playback device O and the x-axis direction are adjusted from the initial a to b. For the user, if the user is currently moving facing the direction indicated by x, that is, adjusting the virtual speaker to behind the user, making the user have the auditory feeling of “throwing the virtual sound source behind.”

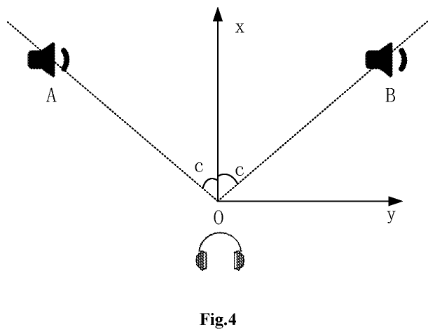

Please refer to FIGS. 2 and 4, in which the x-axis direction is the front direction. If the user's direction of travel is the x-axis direction, then when detecting a decelerated movement, the virtual speaker is adjusted to be in the direction indicated by x, the angles between the lines connecting virtual speakers A and B and audio playback device O and the x-axis direction are adjusted from the initial a to c. For the user, if the user is currently moving facing the direction indicated by x, that is, adjusting the virtual speaker to the front of the user, making the user have the auditory feeling of being “thrown behind” by the virtual sound source, which can encourage the user to accelerate to chase the virtual sound source, enhancing the sound interaction in motion.

In one example, the angle and distance information of the virtual speaker relative to the user is adjusted according to the user's acceleration, specifically including:

When a value (e.g., an absolute value) of the user's acceleration obtained is equal to 0, the distance to the user in the position information of at least two virtual speakers is set to 0, and the angle to the user in the angle information of at least two virtual speakers is set to 0, that is, the sound effect is adjusted to return to the ear.

When a value of the user's acceleration obtained is greater than a preset first threshold, the distance to the user in the position information of at least two virtual speakers is set to a preset second threshold, and the angle to the user in the angle information of at least two virtual speakers is set to a preset third threshold.

When a value of the user's acceleration obtained is greater than 0 and less than the first threshold, the distance to the user in the position information of at least two virtual speakers is adjusted according to a preset first linear relationship, and the angle to the user in the angle information of at least two virtual speakers is adjusted according to a preset second linear relationship.

When a value of the user's acceleration obtained is greater than 0 and less than the first threshold, the distance to the user in the position information of at least two virtual speakers is adjusted according to a preset first linear relationship, and the angle to the user in the angle information of at least two virtual speakers is adjusted according to a preset second linear relationship.

The first linear relationship between the distance of the virtual speaker relative to the user and the user's acceleration, and the second linear relationship between the angle of the virtual speaker relative to the user and the user's acceleration can be determined (e.g., preset). When a value of the user's acceleration detected is greater than 0 and less than the first threshold, the angle and distance of each virtual speaker relative to the user can be adjusted according to the first and second linear relationships. In another implementation, the correspondence table between acceleration and angle and distance can be determined according to the preset first and second linear relationships. After determining the current acceleration, the angle and distance corresponding to the current acceleration are searched in the correspondence table, and the angle and distance parameters in the sound effect function are adjusted using the searched angle and distance. The correspondence table between acceleration and angle and distance parameters is as shown in the following table, which divides acceleration into multiple acceleration ranges, each acceleration value range corresponding to a respective angle and distance. The angle value and distance value corresponding to the acceleration range into which the searched current acceleration falls are used as the new angle parameters and distance parameters in the sound effect function, thereby obtaining two virtual speakers with determined positions relative to the audio playback device.

| | Angle | | Distance | |
|---|---|---|---|---|
| | Virtual | Virtual | Virtual | Virtual |
| Acceleration | speaker A | speaker B | speaker A | speaker B |
| a11~a12 | θ11 | θ11 | L1 | L1 |
| A13~a14 | θ12 | θ12 | L2 | L2 |
| . . . | . . . | . . . | . . . | . . . |

The dual virtual speakers in each example are symmetrically arranged. Therefore, in the case of straight-line acceleration or deceleration movement, the movement direction of the virtual speaker relative to the audio playback device is symmetrical, and its angle and distance remain the same. The present application is illustrated with the example of dual-channel sound effects, and the same method can also be applied to multi-channel sound sources. Limited by the Bluetooth transmission protocol, the audio that can now be transmitted by headphones is all stereo audio. The upmix algorithm can be used to build audio files from stereo to multi-channel (such as 5.1, etc.), and it can also be done through deep learning. The method of instrument separation can decompose stereo music files into multi-channel files covering different instruments. Understandably, multi-channel sound sources can correspond to two or more virtual speakers. This method can also imitate the above method to set the linear relationship between the angle and acceleration of each virtual speaker according to actual needs, and the linear relationship between distance and acceleration, without too much restriction here.

Among them, the first linear relationship is that the ratio of the first threshold to the second threshold is equal to the ratio of the user's currently obtained acceleration to the distance of the virtual speaker relative to the user. The second linear relationship is that the ratio of the first threshold to the third threshold is equal to the ratio of the user's currently obtained acceleration to the angle of the virtual speaker relative to the user.

The first linear relationship between acceleration and the distance from the user in the position information of the virtual speaker during accelerated movement can generally be manifested (e.g., described) as: when the audio playback device is detected to accelerate and the acceleration increases, the virtual speaker moves to the front of the user, and the distance between the audio playback device and the virtual speaker increases. When the audio playback device is detected to accelerate and the acceleration decreases, the distance between the audio playback device and the virtual speaker decreases. When the acceleration is 0, the virtual speaker returns to the side of the ear. The first linear relationship between acceleration and distance during decelerated movement (e.g., slowing down) can generally be manifested as: when the audio playback device is detected to decelerate and the acceleration increases, the virtual speaker moves to the front of the user, and the distance between the audio playback device and the virtual speaker increases; when the audio playback device is detected to decelerate and the deceleration decreases, the distance between the audio playback device and the virtual speaker decreases; when the deceleration is 0, the virtual speaker returns to the side of the ear.

The second linear relationship between acceleration and the angle relative to the user in the position information of the virtual speaker during accelerated movement can generally be manifested as: when the audio playback device is detected to accelerate and the acceleration increases, the virtual speaker moves to the back of the user, and the angle formed by the line between the audio playback device and the virtual speaker and the front of the audio playback device decreases, but it may be still greater than 90 degrees. When the audio playback device is detected to accelerate and the acceleration decreases, the angle formed by the line between the audio playback device and the virtual speaker and the front of the audio playback device increases. When the acceleration is 0, the virtual speaker returns to the side of the ear. The second linear relationship between acceleration and the angle relative to the user in the position information of the virtual speaker during decelerated movement can generally be manifested as: when the audio playback device is detected to decelerate and the acceleration increases, the virtual speaker moves to the front of the user, and the angle formed by the line between the audio playback device and the virtual speaker and the front of the audio playback device increases, but it is still less than 90 degrees; when the audio playback device is detected to decelerate and the acceleration decreases, the angle formed by the line between the audio playback device and the virtual speaker and the front of the audio playback device decreases; when the acceleration is 0, the virtual speaker returns to the side of the ear.

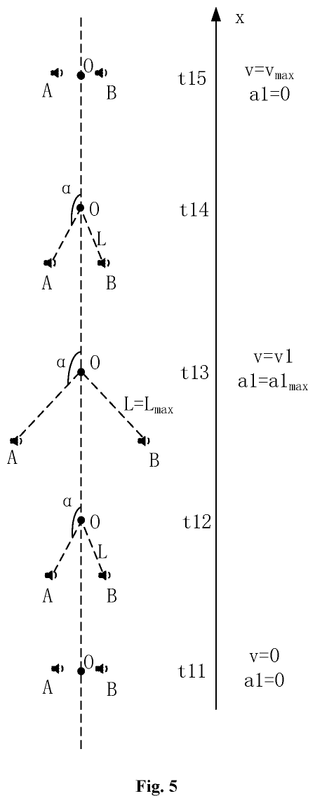

Please refer to FIG. 5, which shows the change in the positional relationship between the audio playback device and the virtual speaker during the complete acceleration process towards the x direction from the static moment t11 to t12-t13-t14-t15, where O represents the center position of the audio playback device, and A and B represent the two virtual speakers under the dual sound source effect. Between t11-t12-t13, the speed v increases from 0 to v1, the acceleration a1 increases from 0 to the maximum acceleration almax, the virtual speaker moves from the ear to the back, the angle formed by the line between the virtual speaker A and the audio playback device O and the front of the audio playback device O, and the angle formed by the line between the virtual speaker B and the audio playback device and the front of the audio playback device both decrease from large to small, but they may be greater than 90 degrees. At the same time, the distance L between the virtual speakers A, B and the audio playback device O increases from small to large to Lmax. Between t13-t14-t15, the speed increases from v1 to vmax, the acceleration a1 decreases from the maximum acceleration almax to 0, the angle formed by the line between the virtual speaker A and the audio playback device O and the front of the audio playback device O, and the angle formed by the line between the virtual speaker B and the audio playback device and the front of the audio playback device both increase from small to large, at the same time, the distance L between the virtual speakers A, B and the audio playback device O decreases from Lmax, until the speed increases to the maximum speed vmax. When the acceleration a1 becomes 0, the virtual speakers return to the side of the ear (e.g., the virtual speakers and the audio playback device are on the same line).

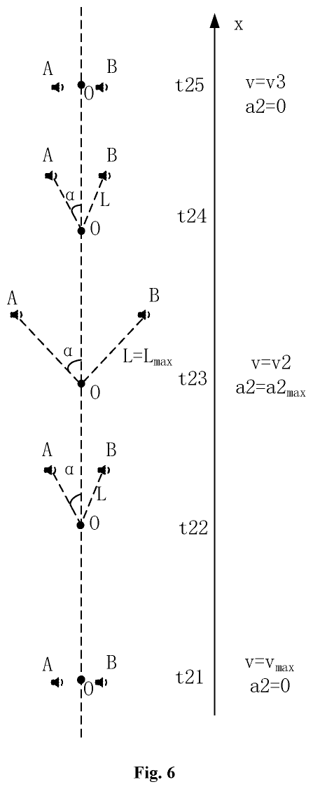

Please refer to FIG. 6, which shows the change in the positional relationship between the audio playback device and the virtual speaker during the complete deceleration process towards the x direction from the static moment t21 to t22-t23-t24-t25, where O represents the center position of the audio playback device, and A and B represent the two virtual speakers under the dual sound source effect. Between t21-t22-t23, the speed v decreases from the maximum speed vmax to v2, the acceleration a2 increases from 0 to the maximum acceleration a2max, the virtual speaker moves from the ear to the front, the angle formed by the line between the virtual speaker A and the audio playback device O and the front of the audio playback device O, and the angle formed by the line between the virtual speaker B and the audio playback device and the front of the audio playback device both increase from small to large, but they may be less than 90 degrees. Between t23-t24-t25, the speed decreases from v2 to v3, the acceleration a2 decreases from the maximum acceleration a2max to 0, the angle formed by the line between the virtual speaker A and the audio playback device O and the front of the audio playback device O, and the angle formed by the line between the virtual speaker B and the audio playback device and the front of the audio playback device both decrease from large to small, until the acceleration a2 becomes 0, and the virtual speakers return to the side of the ear.

Please continue to refer to FIG. 6, between t21-t22-t23, the speed v decreases from the maximum speed vmax to v2, the acceleration a2 increases from 0 to the maximum acceleration a2max, the virtual speaker moves from the ear to the front, the distance L between the virtual speakers A, B and the audio playback device O respectively increases from small to large to Lmax. Between t23-t24-t25, the speed decreases from v2 to v3, the acceleration a2 decreases from the maximum acceleration a2max to 0, the distance L between the virtual speakers A, B and the audio playback device O respectively decreases from Lmax, until the acceleration a2 becomes 0, and the virtual speakers return to the side of the ear.

The motion information may also comprise velocity information. In the above examples, the angle between the user and each virtual speaker may have a set linear relationship with the acceleration and velocity during acceleration or deceleration. The distance between the user and each virtual speaker may also have a set linear relationship with the acceleration and velocity during deceleration or deceleration. The corresponding angle parameters and distance parameters can be determined according to the current acceleration, velocity and the set linear relationship. This will not be further elaborated here.

In other implementation scenarios, the motion trajectory comprises trajectory information of acceleration turning movement and deceleration turning movement. For example, a computing device can simultaneously obtain the turning information of the audio playback device, as well as the information of whether to accelerate and/or whether to decelerate. Among them, the turning information can identify the current motion trajectory of the audio playback device based on the map positioned by GPS (Global Positioning System), and determine the turning information of the audio playback device based on the turning information of the current road section where the audio playback device is located. Further, the computing device can also obtain the turning information from sensors such as gyroscopes set on the audio playback device or mobile devices that can be carried and can communicate with the audio playback device.

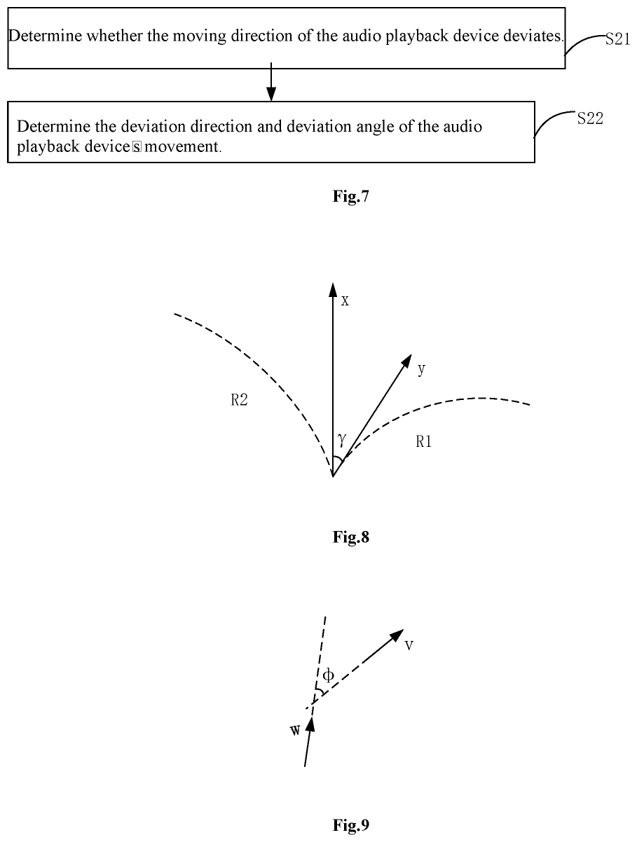

Please refer to FIG. 7, which is a schematic diagram of the process of determining the turning information in one example of this application. This method may be performed by a computing device such an audio player device, a server, a mobile phone, etc. This method comprises the following steps:

Step S21: Determine whether the moving direction of the audio playback device deviates (e.g., from a predetermined direction).

In this step, GPS positioning technology can be used to identify the current road where the audio playback device is located, and determine the angle between the extension direction of the road and the current moving direction of the audio playback device. When the angle exceeds a set angle threshold, it can be determined that the moving direction of the audio playback device deviates. Please refer to FIG. 8, where x is the current moving direction of the audio playback device, y is the extension direction of road section R1, and the angle between them can be represented as γ. In addition, a computing device can collect the orientation of the audio playback device at a set interval, when the angle between the current orientation of the audio playback device and the orientation of the previous moment exceeds the set angle threshold, the computing device can determine that the moving direction of the audio playback device deviates. Please refer to FIG. 9, where the orientation of the audio playback device at the previous moment is w, the orientation of the audio playback device at the previous moment is v, and the angle can be represented as φ. When the angle does not exceed the set angle threshold, is the computing device can determine that there is no deviation.

Step S22: Determine the deviation direction and deviation angle of the audio playback device's movement.

The deviation angle can be determined according to the method of determining the angle in the previous step, which will not be further elaborated here.

As for the direction of movement deviation, it can be determined based on the deviation direction of the current moving direction of the audio playback device relative to the extension direction of the road. Please refer to FIG. 8, if the audio playback device changes from direction x to travel along road section R1, it can be determined that the moving deviation direction of the audio playback device is to the right. If the audio playback device changes from direction x to travel along road section R2, it can be determined that the moving deviation direction of the audio playback device is to the left. Alternatively, it can be determined based on the deviation direction between the current orientation of the audio playback device and the orientation of the audio playback device at the previous moment. Please refer to FIG. 9, the current orientation v of the audio playback device deviates to the right relative to the current orientation w of the audio playback device, and the computing device can determine that the moving deviation direction of the audio playback device is to the right.

The computing device may be configured to control (e.g., adjust) the location of the virtual speakers based on the movement of the audio playback device. For example, in the case where the audio playback device follows the user to turn: When the motion trajectory is accelerating and turning, at least two virtual speakers are adjusted to be on the opposite side of the moving direction of the audio playback device and the opposite side of the turning direction. When the motion trajectory is decelerating and turning, at least two virtual speakers are adjusted to be on the same direction as the moving direction of the audio playback device and the opposite side of the turning direction. For example, if the audio playback device accelerates to the left with the user, the virtual speaker is adjusted to the right rear of the audio playback device. If the audio playback device decelerates to the right with the user, the virtual speaker is adjusted to the left front of the audio playback device.

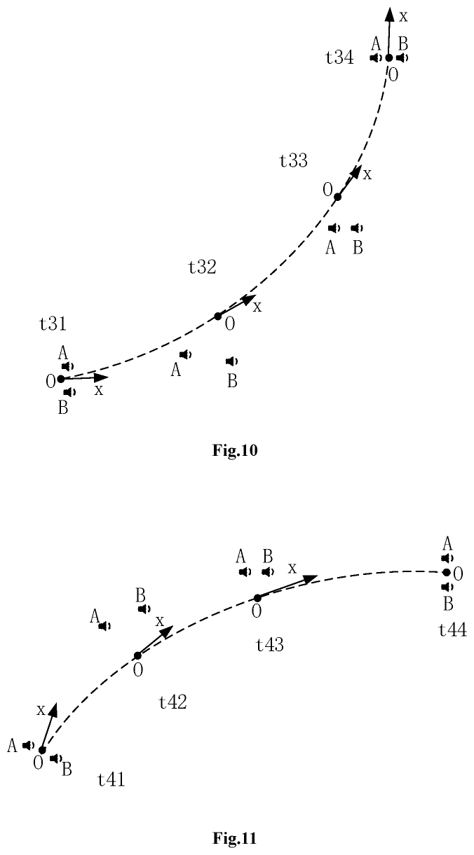

Please refer to FIGS. 10-11, specifically, where O represents the center position of the audio playback device, and A and B are the two virtual speakers under the dual sound source effect. FIG. 10 shows a schematic diagram of the relative position between the audio playback device and the virtual speaker in the case of acceleration and turning. The audio playback device O accelerates and turns along the turning path from t31 to t32-t33-t34. x is the orientation of the audio playback device at each moment, taking the direction pointed by x as the front of the audio playback device O, then during this acceleration process, the audio playback device O accelerates to the left, and the two virtual speakers A and B are located at the rear of the audio playback device O (e.g., at least one of the two virtual speakers A and B has an angle greater than 90 degrees with the line between it and the audio playback device O and the front of the audio playback device O). FIG. 11 is a schematic diagram of the relative position between the audio playback device and the virtual speaker in the case of deceleration and turning. The audio playback device O decelerates and turns along the turning path from t41 to t42-t43-t44. x is the orientation of the audio playback device at each moment, taking the direction pointed by x as the front of the audio playback device O, then during this deceleration process, the audio playback device O decelerates to the right, and the two virtual speakers A and B are located at the front of the audio playback device O (e.g., at least one of the two virtual speakers A and B has an angle less than 90 degrees with the line between it and the audio playback device O and the front of the audio playback device O).

In the process of accelerating or decelerating and turning, the angle between each virtual speaker and the audio playback device may have a linear relationship with the acceleration and the deviation angle respectively. Understandably, the angle between each virtual speaker and the audio playback device has different linear relationships with the acceleration and the deviation angle respectively. During the turning process, the sound field formed by the virtual speaker deviates from the user in the left and right directions.

When it is detected that the user's head is turning left and right, the head rotation angle information detected in real time by the head tracking device set on the audio playback device is obtained. Based on the obtained head rotation angle information, and the preset head rotation angle adjustment mechanism, the angle information of the at least two virtual speakers is adjusted. Specifically, when the user's head turns to the left, the angle between the virtual speaker on the left side of the user's head and the horizontal line of the user, and the angle directly in front of the user, may be reduced, and the angle between the virtual speaker on the right side of the user's head and the horizontal line of the user, and the angle directly in front of the user, may be increased. When the user's head turns to the right, the angle between the virtual speaker on the right side of the user's head and the horizontal line of the user, and the angle directly in front of the user, may be reduced, and the angle between the virtual speaker on the left side of the user's head and the horizontal line of the user, and the angle directly in front of the user, may be increased.

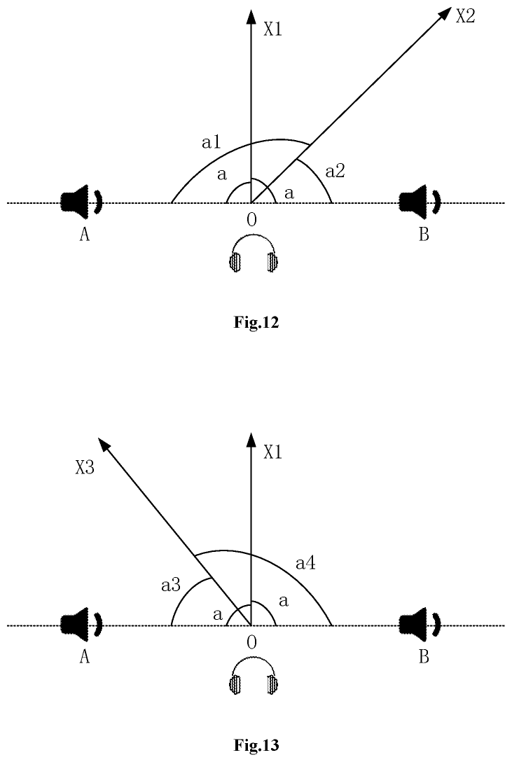

Please refer to FIGS. 12 and 13, X1, X2, X3 are directly in front of the user's head, O is the position of the audio playback device and the user. Before the user's head turns, the direction directly in front of the user's head is X1. When the user's head turns to the right to the X2 direction, the angle between the virtual speaker B on the right side of the user's head and the horizontal line of the user O, and the X2 direction directly in front of the user, may be reduced to a2, and the angle between the virtual speaker A on the left side of the user's head and the horizontal line of the user, and the X2 direction directly in front of the user, may be increased to a1. When the user's head turns to the left to the X3 direction, the angle between the virtual speaker B on the right side of the user's head and the horizontal line of the user O, and the X3 direction directly in front of the user, may be increased to a4, and the angle between the virtual speaker A on the left side of the user's head and the horizontal line of the user, and the X3 direction directly in front of the user, may be reduced to a3.

Understandably, the angle parameters in the above examples can also be the angles formed between the lines connecting two or more virtual speakers to the user's coordinate center. As long as it can adjust the angle between the line connecting the virtual speaker and the audio playback device, and the direction directly in front of the audio playback device, it can be considered as a replaceable scheme of the angle parameters of this application and should be considered within the scope of this scheme's request for protection.

Step S14: Use (e.g., control) the audio playback device to play (e.g., output) spatial audio data.

The previous step processes the audio data to be processed to obtain the processed spatial audio data. This step uses the audio device to play the spatial audio data. This spatial audio data may be adjusted according to the user's motion information and may have corresponding spatial features. During the user's continuous movement process, the spatial features of the played audio change accordingly with the change of the movement state.

Different from the existing technology, this example adjusts the position parameters in the sound effect function according to the motion information perceived by the audio playback device with the user's movement, thereby adjusting the angle and distance between the virtual speaker and the audio playback device (e.g., adjusting the position of the virtual speaker relative to the user), ultimately achieving the purpose of adjusting the sound effect. The audio playback effect dynamically changes with the change of motion information, giving the audio a more vivid expression effect, enhancing the user's sense of presence, meeting the user's emotional needs for an “audio companion,” beneficial to enhance the exercise experience, and can guide users to better achieve their exercise goals.

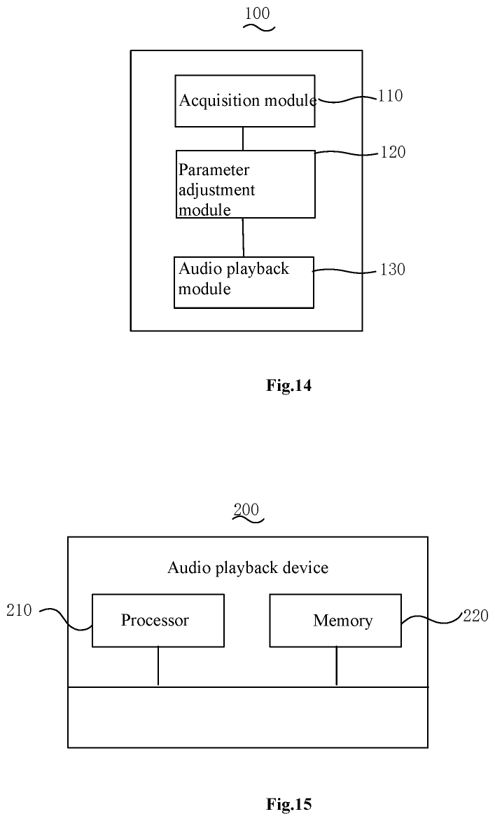

Please refer to FIG. 14, which is a schematic diagram of the structure of an example of the audio playback device of this application.

The audio playback device 100 comprises an acquisition module 110, a parameter adjustment module 120, and an audio playback module 130. The acquisition module 110 is configured to acquire the audio data to be processed by the audio playback device, and to acquire the motion information of the audio playback device following the user. The parameter adjustment module 120 is configured to adjust the position parameters between the audio playback device and the virtual speaker in the sound effect function based on the motion information. The position parameters comprises the angle parameters of the audio playback device and the virtual speaker in the horizontal direction. The position of the virtual speaker comprises the virtual sound source position after the sound effect function processing. The audio playback module 130 is configured to convert the audio data to be processed into data to be played using the adjusted sound effect function, and the audio playback device outputs the data to be played.

In addition, the audio playback device 100 may also comprise a communication module (not shown in the figure), which is used to establish a wired or wireless communication connection with the audio source device to receive audio data to be processed from the audio source device.

For example, the audio source device can be a mobile phone, tablet computer, and wearable audio source devices such as watches and bracelets. The audio source device can store local audio data, or it can obtain audio data from applications or web pages through the network as audio data to be processed. The audio data to be processed can be music audio data, electronic reading audio data, TV/movie audio, etc.

For the specific methods of each step of the processing, please refer to the descriptions of each step of the audio processing method example of this application, and it will not be repeated here.

Please refer to FIG. 15, which is a schematic diagram of the structure of another example of the audio playback device of this application. This audio playback device 200 includes a processor 210 and a storage 220 that are coupled to each other. The storage 220 stores a computer program, and the processor 210 executes the computer program to implement the audio processing method described in the above examples.

For the description of each step of the processing, please refer to the descriptions of each step of the audio processing method example of this application, and it will not be repeated here.

The storage 220 can be used to store program data and modules, and the processor 210 executes various function applications and data processing by running the program data and modules stored in the storage 220. The storage 220 can mainly include a program storage area and a data storage area. The program storage area can store an operating system, at least one application program required for a function (such as parameter adjustment function, etc.). The data storage area can store data created based on the use of the audio playback device 200 (such as audio data to be processed, motion information data, etc.). In addition, the storage 220 can comprise high-speed random access memory and can also include non-volatile memory, such as at least one magnetic disk storage device, flash device, or other volatile solid-state storage device. Accordingly, the storage 220 can also comprise a memory controller to provide access to the storage 220 by the processor 210.

In each example of this application, the disclosed methods and devices can be implemented in other ways. For example, the various examples of the audio playback device 200 described above are merely illustrative. For example, the division of the modules or units is just a logical function division. There can be other division methods in actual implementation. For example, multiple units or components can be combined or integrated into another system, or some features can be ignored or not executed. On another point, the coupling or direct coupling or communication connection discussed or displayed between each other can be indirect coupling or communication connection through some interfaces, devices or units, which can be electrical, mechanical or other forms.

The units described as separate components can be or may not be physically separated, the components displayed as units can be or may not be physical units, i.e., they can be located in one place, or they can be distributed over multiple network units. You can choose some or all of the units to achieve the purpose of this implementation scheme according to actual needs.

In addition, in each example of this application, each functional unit can be integrated in one processing unit, or each unit can physically exist separately, or two or more units can be integrated in one unit. The integrated units mentioned above can be implemented in the form of hardware, or they can be implemented in the form of software functional units.

If the integrated unit is implemented in the form of a software functional unit and is sold or used as an independent product, it can be stored in a computer-readable storage medium. Based on this understanding, the technical solution of this application, or the part that contributes to the existing technology, or all or part of this technical solution, can be embodied in the form of a software product, and this computer software product is stored in a storage medium.

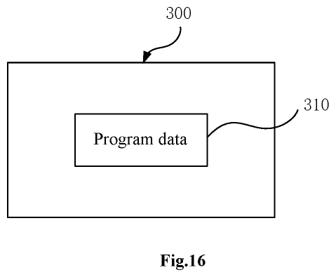

Refer to FIG. 16, FIG. 16 shows a schematic diagram of the structure of an example of a non-transitory computer-readable storage medium of this application. The non-transitory computer-readable storage medium 300 stores program data 310, and when the program data 310 is executed, it implements the steps of the audio processing method described above. For the description of each step of the processing, please refer to the descriptions of each step of the audio processing method example of this application, and it will not be repeated here.

The computer-readable storage medium 300 can be a USB flash drive, mobile hard disk, read-only memory (ROM), random access memory (RAM), magnetic disk, optical disk, or other media that can store program code.

The above are only examples of this application and do not limit the patent scope of this application. Any equivalent structure or equivalent process transformation made using the content of this application specification and drawings, or directly or indirectly applied in other related technical fields, are also included in the patent protection scope of this application.

What is claimed is:

1. An audio processing method comprising:
obtaining, based on movement of a user, motion information of an audio playback device, wherein the motion information comprises a motion trajectory of the audio playback device, real-time motion speed of the audio playback device, and an acceleration of the audio playback device;
based on the obtained motion information and a preset sound effect function, determining position information and angle information of at least two virtual speakers relative to the user;
based on the preset sound effect function, and the determined position information and angle information of the at least two virtual speakers, determining spatial audio data; and
outputting the spatial audio data via the audio playback device.

2. The method of claim 1, wherein the determining the angle information comprises:
obtaining, by the audio playback device, head rotation angle information of the user; and
based on the obtained head rotation angle information, and a preset head rotation angle adjustment rule, adjusting the angle information of the at least two virtual speakers.

3. The method of claim 2, wherein the head rotation angle adjustment rule comprises:
based on detecting the user's head turning to the left, decreasing a first angle between a virtual speaker on a left side of the user's head and a horizontal line of the user, and the angle directly in front of the user, and increasing a second angle between a virtual speaker on a right side of the user's head and the horizontal line of the user, and the angle directly in front of the user; and
based on detecting the user's head turning to the right, decreasing the second angle between the virtual speaker on the right side of the user's head and the horizontal line of the user, and the angle directly in front of the user, and increasing the first angle between the virtual speaker on the left side of the user's head and the horizontal line of the user, and the angle directly in front of the user.

4. The method of claim 1, further comprising determining the sound effect function by:
based on the acceleration being greater than a preset first threshold, setting a distance relative to the user in the position information to a preset second threshold, and setting an angle relative to the user in the angle information to a preset third threshold;
based on the acceleration being equal to 0, setting the distance to 0, and setting the angle to 0; and
based on the acceleration being greater than 0 and less than the first threshold, setting the distance to a preset first linear relationship, and setting the angle to a preset second linear relationship.

5. The method of claim 4, wherein the first linear relationship indicates that a ratio of the first threshold to the second threshold is equal to a ratio of the acceleration to the distance, and the second linear relationship indicates that a ratio of the first threshold to the third threshold is equal to a ratio of the acceleration to the angle.

6. The method of claim 1, wherein the obtaining the motion information comprises obtaining the motion information by a positioning device and an acceleration sensor, and wherein at least one of the positioning device and the acceleration sensor is set on the audio playback device, or is included in a smart mobile device that is communicatively connected to the audio playback device.

7. The method of claim 1, further comprising:
determining, based on the acceleration being greater than 0, that each of the at least two virtual speakers is located in a direction opposite to a direction of movement of the audio playback device; and
determining, based on the acceleration being less than 0, that the at least two virtual speakers are located in the same direction as the direction of movement of the audio playback device.

8. The method of claim 1, wherein the motion trajectory comprises acceleration turning movement and deceleration turning movement;
the acceleration turning movement indicates that the at least two virtual speakers are located on a side opposite to a turning direction and in the direction opposite to the direction of movement of the audio playback device; and
the deceleration turning movement indicates that the at least two virtual speakers are located on the side opposite to the turning direction and in the same direction as the direction of movement of the audio playback device.

9. An audio playback device comprising:
one or more processors; and
memory storing instructions that, when executed by the one or more processors, cause the audio playback device to:
obtain, based on movement of a user, motion information of the audio playback device, wherein the motion information comprises a motion trajectory of the audio playback device, real-time motion speed of the audio playback device, and an acceleration of the audio playback device;
based on the obtained motion information and a preset sound effect function, determine position information and angle information of at least two virtual speakers relative to the user;
based on the preset sound effect function, and the determined position information and angle information of the at least two virtual speakers, determine spatial audio data; and
output the spatial audio data.

10. The audio playback device of claim 9, wherein the instructions, when executed by the one or more processors, cause the audio playback device to:
obtain head rotation angle information of the user; and
based on the obtained head rotation angle information, and a preset head rotation angle adjustment rule, adjust the angle information of the at least two virtual speakers.

11. The audio playback device of claim 10, wherein the head rotation angle adjustment rule comprises:
based on detecting the user's head turning to the left, decreasing a first angle between a virtual speaker on a left side of the user's head and a horizontal line of the user, and the angle directly in front of the user, and increasing a second angle between a virtual speaker on a right side of the user's head and the horizontal line of the user, and the angle directly in front of the user; and
based on detecting the user's head turning to the right, decreasing the second angle between the virtual speaker on the right side of the user's head and the horizontal line of the user, and the angle directly in front of the user, and increasing the first angle between the virtual speaker on the left side of the user's head and the horizontal line of the user, and the angle directly in front of the user.

12. The audio playback device of claim 9, wherein the instructions, when executed by the one or more processors, cause the audio playback device to determine the sound effect function by:
based on the acceleration being greater than a preset first threshold, setting a distance relative to the user in the position information to a preset second threshold, and setting an angle relative to the user in the angle information to a preset third threshold;
based on the acceleration being equal to 0, setting the distance to 0, and setting the angle to 0; and
based on the acceleration being greater than 0 and less than the first threshold, setting the distance to a preset first linear relationship, and setting the angle to a preset second linear relationship.

13. The audio playback device of claim 12, wherein the first linear relationship indicates that a ratio of the first threshold to the second threshold is equal to a ratio of the acceleration to the distance, and the second linear relationship indicates that a ratio of the first threshold to the third threshold is equal to a ratio of the acceleration to the angle.

14. The audio playback device of claim 9, wherein the instructions, when executed by the one or more processors, cause the audio playback device to obtain the motion information by obtaining the motion information by a positioning device and an acceleration sensor, and wherein at least one of the positioning device and the acceleration sensor is set on the audio playback device, or is included in a smart mobile device that is communicatively connected to the audio playback device.

15. The audio playback device of claim 9, wherein the instructions, when executed by the one or more processors, cause the audio playback device to:
determine, based on the acceleration being greater than 0, that each of the at least two virtual speakers is located in a direction opposite to a direction of movement of the audio playback device; and
determine, based on the acceleration being less than 0, that the at least two virtual speakers are located in the same direction as the direction of movement of the audio playback device.

16. The audio playback device of claim 9, wherein the motion trajectory comprises acceleration turning movement and deceleration turning movement;
the acceleration turning movement indicates that the at least two virtual speakers are located on a side opposite to a turning direction and in the direction opposite to the direction of movement of the audio playback device; and
the deceleration turning movement indicates that the at least two virtual speakers are located on the side opposite to the turning direction and in the same direction as the direction of movement of the audio playback device.

17. A non-transitory computer-readable storage medium storing instructions, when executed, cause:
obtaining, based on movement of a user, motion information of an audio playback device, wherein the motion information comprises a motion trajectory of the audio playback device, real-time motion speed of the audio playback device, and an acceleration of the audio playback device;
based on the obtained motion information and a preset sound effect function, determining position information and angle information of at least two virtual speakers relative to the user;
based on the preset sound effect function, and the determined position information and angle information of the at least two virtual speakers, determining spatial audio data; and
outputting the spatial audio data via the audio playback device.

18. The non-transitory computer-readable storage medium of claim 17, wherein the instructions, when executed, cause the determining the angle information by causing:
obtaining head rotation angle information of the user; and
based on the obtained head rotation angle information, and a preset head rotation angle adjustment rule, adjusting the angle information of the at least two virtual speakers.

19. The non-transitory computer-readable storage medium of claim 18, wherein the head rotation angle adjustment rule comprises:
based on detecting the user's head turning to the left, decreasing a first angle between a virtual speaker on a left side of the user's head and a horizontal line of the user, and the angle directly in front of the user, and increasing a second angle between a virtual speaker on a right side of the user's head and the horizontal line of the user, and the angle directly in front of the user; and
based on detecting the user's head turning to the right, decreasing the second angle between the virtual speaker on the right side of the user's head and the horizontal line of the user, and the angle directly in front of the user, and increasing the first angle between the virtual speaker on the left side of the user's head and the horizontal line of the user, and the angle directly in front of the user.

20. The non-transitory computer-readable storage medium of claim 17, wherein the instructions, when executed, cause determining the sound effect function by:
based on the acceleration being greater than a preset first threshold, setting a distance relative to the user in the position information to a preset second threshold, and setting an angle relative to the user in the angle information to a preset third threshold;
based on the acceleration being equal to 0, setting the distance to 0, and setting the angle to 0; and
based on the acceleration being greater than 0 and less than the first threshold, setting the distance to a preset first linear relationship, and setting the angle to a preset second linear relationship.
